(19) United States
(12) Patent Application Publication
(10) Pub. No.: US 2022/0304330 A1
(43) Pub. Date: Sep. 29, 2022

(54) MECHANIZED PRODUCTION LINE FOR FALOODEH (FALOUDEH) AND PREPARATION METHOD

(71) Applicant: Mohammadmehdi MISAGH, Shiraz (IR)

(72) Inventor: Mohammadmehdi MISAGH, Shiraz (IR)

(21) Appl. No.: 17/284,956

(22) PCT Filed: Nov. 5, 2020
(86) PCT No.: PCT/IR2020/050037

§ 371 Date: Apr. 13, 2021

(51) Int. Cl. A23G 9/12; A23G 9/44; A21C 11/16; A23G 3/02

(52) U.S. Cl. CPC A23G 9/12; A23G 9/44; A21C 11/16; A23G 3/0236

(57) ABSTRACT

Disclosed herein is a mechanized production line of floodeh (faloudeh) comprising three main sections including, faloodeh (faloudeh) noodle production section, syrup production section and mixing & flavoring section. To establish the whole production line 20 sq. meter area to produce 500 Kg of product is needed. The whole production line is made up of stainless steel.

### TECHNICAL FIELD

The present disclosure generally relates to an automated mechanism for producing a frozen dessert named as ice noodle and particularly to a traditional Iranian dessert called Faloodeh (Faloudeh). Shirazi Faloodeh (Faloudeh) is one of the most famous types of this product that can be prepared and produced by the presented disclosure.

### BACKGROUND ART

Frozen dessert has been recognized as a popular part of meal for people in the world; even in some countries, this kind of food is consumed as a refreshing food or snack.

Faloodeh (Faloudeh) has been produced traditionally in Iran in shops and being known among the most popular frozen desserts by Iranians for centuries. The mixture of noodles with sugar syrup with different flavors that are prepared traditionally cannot last more than three days. Also, regarding to the food hygiene, the health of the product cannot be graduated since most parts of the process are manually and exposed.

Mechanizing the production process in a closed loop by utilizing automated machineries designed for producing Faloodeh (Faloudeh) can help to preserve the quality and taste of the product facilitating production standardization regarding food hygiene.

### SUMMARY OF INVENTION

The mechanized production method for Faloodeh (Faloudeh) comprises machineries that are mainly categorized in three main sections namely, Faloodeh Noodle Production, Syrup Production and Mixing and Flavoring. This production method is designed to facilitate Faloodeh (Faloudeh) production in a small or medium size shops and workshops by utilizing special machineries.

### BRIEF DESCRIPTION OF DRAWINGS

FIG. 1: Illustrates a schematic representation of the whole mechanized production method for Faloodeh (Faloudeh)

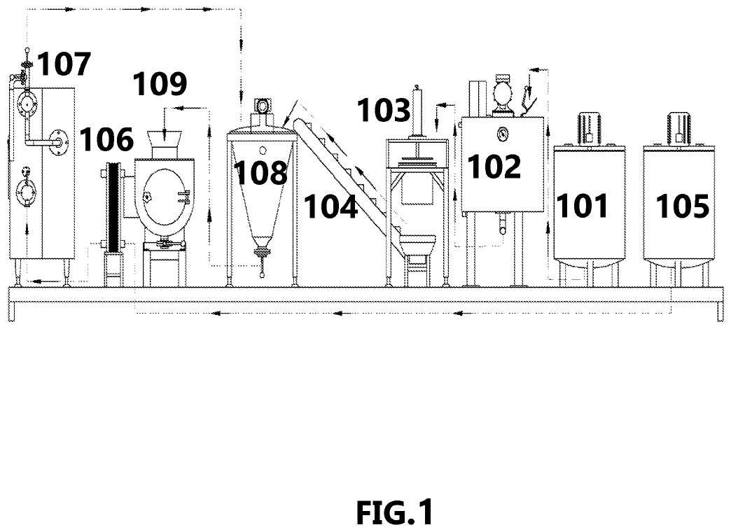

FIG. 2: Illustrates a schematic representation of Primary Processing tank

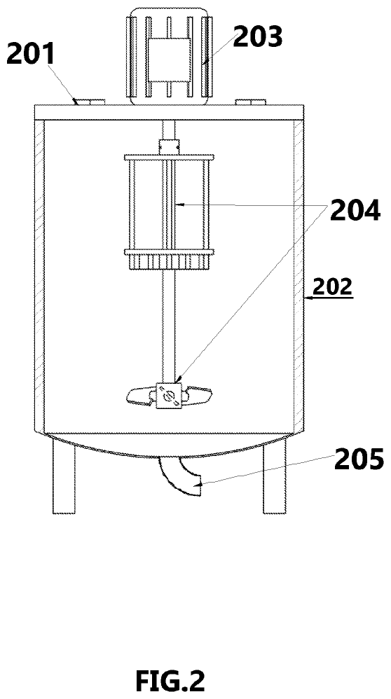

FIG. 3: Illustrates a schematic representation of Cooking Tank

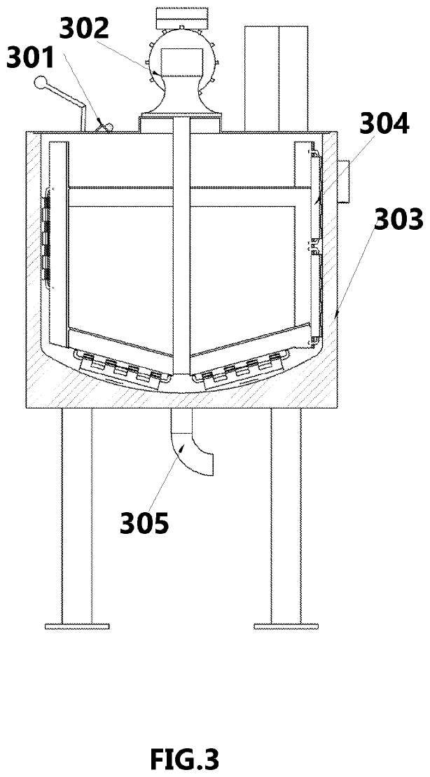

FIG. 4: Illustrates a schematic representation of Extruder Press

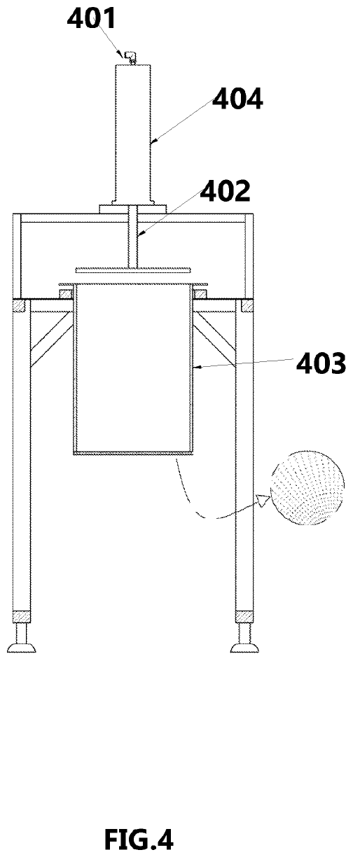

FIG. 5: Illustrates a schematic representation of Drier

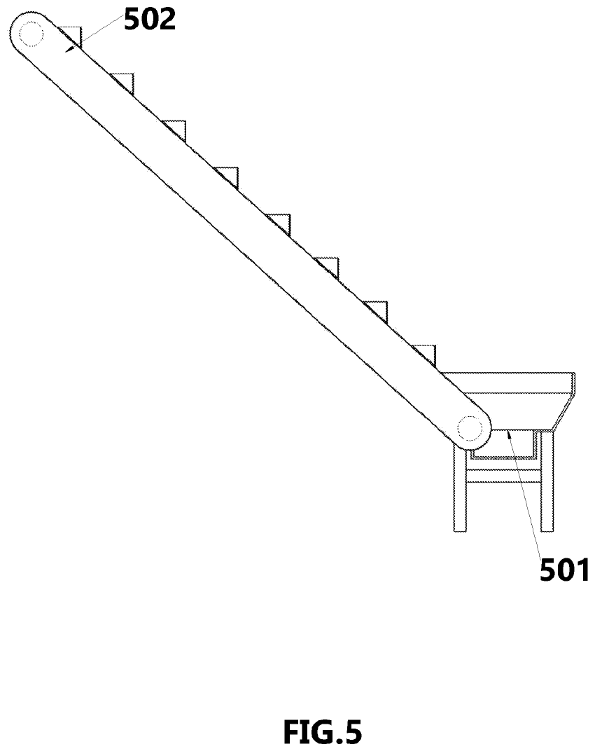

FIG. 6: Illustrates a schematic representation of Primary Processing Tank

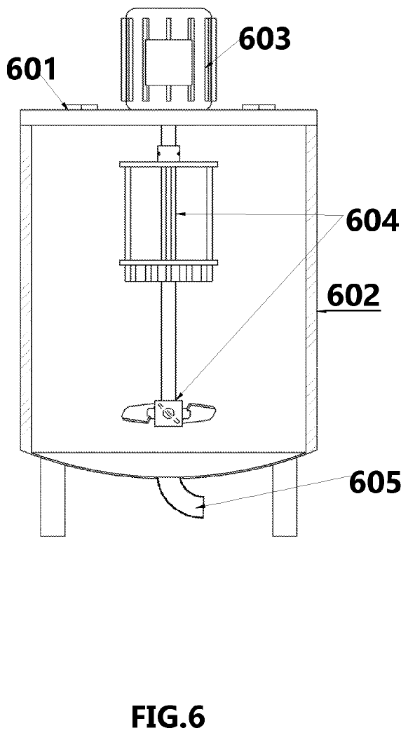

FIG. 7: Illustrates a schematic representation of Water Chiller

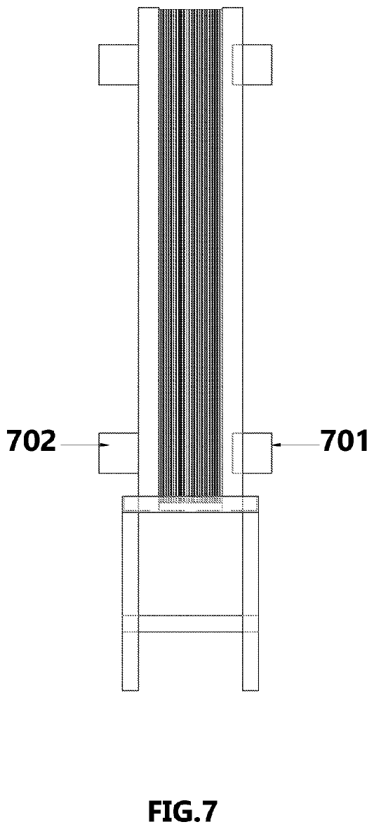

FIG. 8: Illustrates a schematic representation of Batch Freezer

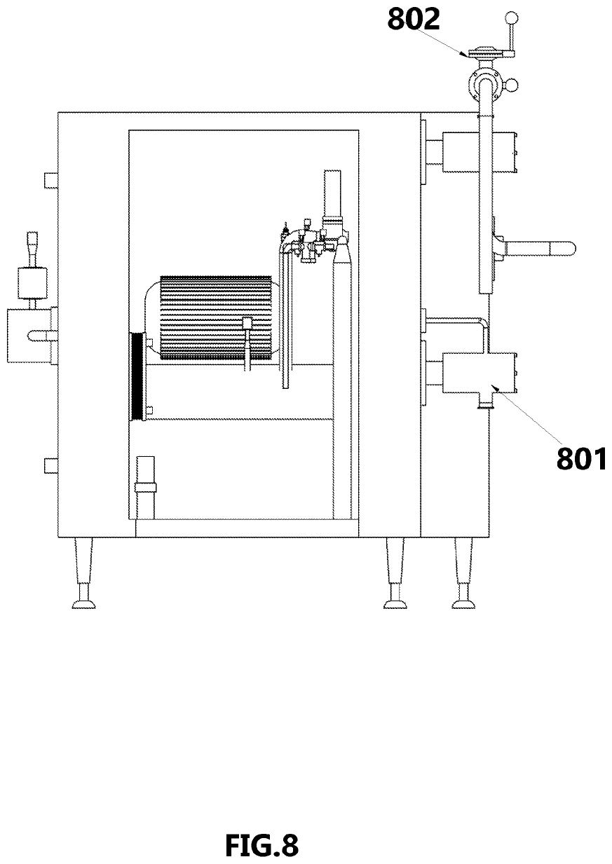

FIG. 9: Illustrates a schematic representation of Primary Mixer

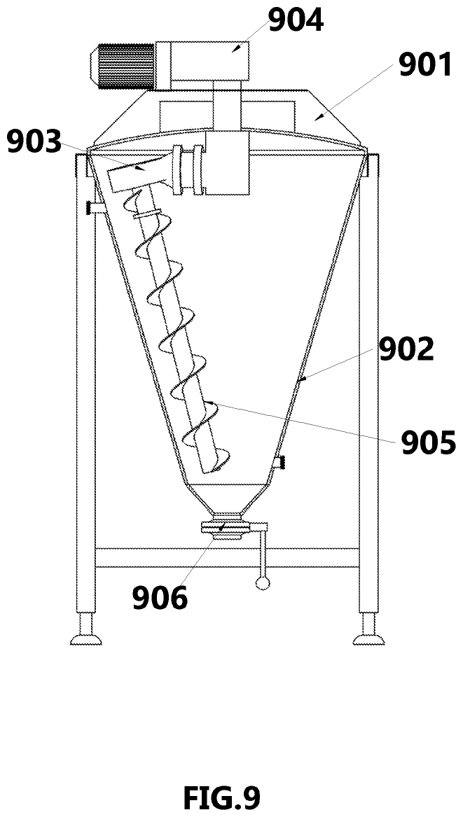

FIG. 10: Illustrates a schematic representation of Secondary Mixer

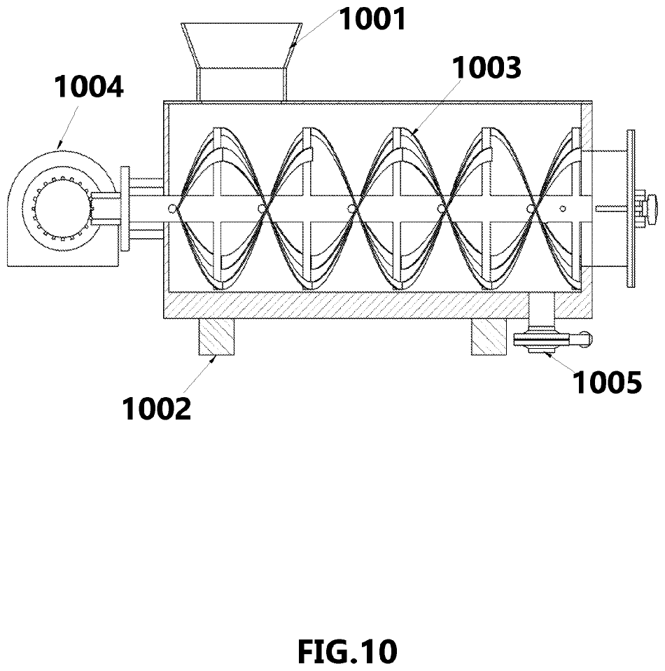

### DETAILED DESCRIPTION

First, the starch, cold water, and any additives needed to cook the Faloodeh (Faloudeh) mixture noodles are poured into the double-walled Faloodeh noodles material mixer tank (109) through the entry of the raw materials to make the Faloodeh noodles.

Inside the tank (104), the mixing blades inside the (108) double-walled Faloodeh noodles material mixer tank (109) are rotated by the rotating shafts of the blades (106) and mix the mixture evenly, the water is then heated by the hot water supply source (heater) (101).

The hot water enters into the middle wall of the double-walled Faloodeh noodles material mixer tank (103) through the inlet of the hot water (102) and heats the air inside the double-walled mixer tank (304), this process lasts until complete cooking of Faloodeh noodle occurs and the heat is uniform.

The cooked mixture is transferred to the noodle extruder (304) in the Faloodeh noodle press machine through the outlet of the mixture of Faloodeh (107) and by Faloodeh noodle materials pressing arm, (10), Faloodeh (109), is taken out and transferred to the storage pool tank for keeping.

This tank (114) contains frozen water and causes the noodle to decrease and the noodle takes a cohesive and fragile form. After the Faloodeh noodle (111) period of resting in the Pool storage tank of Faloodeh noodle (114), Faloodeh noodle is taken into a double-walled mixer and storage tank of Faloodeh and syrup (118) through the inlet of Faloodeh noodle and syrup (116) after mixing with the syrup, noodle and syrup mixture (115) is exited from Faloodeh extruder (119) by the electric gearbox device and transferred to packing containers, Packed in Faloodeh containers, placed on the conveyor for transferring, packaging and finishing process and finally, the Faloodeh containers are packaged and ready to be delivered (121) and produced (120).

On the other hand, the raw materials of syrup production are taken into the double-walled production tank of Faloodeh syrup, through the inlet of the initial production phase of Faloodeh syrup (122). Moreover, the materials are mixed by the mixer blades of Faloodeh syrup tank (123) is mixed by the mixer blades.

After the solubility of the materials is complete, the solution is exited from the outlet of the double-walled Faloodeh syrup production tank (124) and it is stored in the double-walled tank of Faloodeh syrup (128) through the entrance of the double-walled tank of Faloodeh syrup (126) and thickens at an appropriate temperature. Also, the temperature is monitored through the temperature and quality controller of the Faloodeh syrup (127).

Then the solution arrives at room temperature and exits through the outlet of the double-walled storage tank of Faloodeh syrup (129) and enters the double-walled flavor making mixer tank (131) through the place of adding flavor to the Faloodeh syrup (130). In addition to receiving additives, the syrup is cooled to be prepared for mixing with the noodles (111).

1. The mechanized production line of faloodeh (faloudeh) production comprising: faloodeh noodle production section [101,102,103,104], syrup production section [105,106,107] and mixing & flavoring section [108,109].

2. The faloodeh noodle production of claim 1, further comprising primary processing tank [101], and a two-layer container [202] with an electro gearbox mounted on the top [203] and an agitator inside [204] which blades of the agitator attached to a rotating vertical shaft, which rotates by the electro gearbox and is concentric with the two-layer container and the tank inlet [201] is positioned on the top, and the outlet [205] is at the bottom of container connected by a pipeline to a cooking tank [102] and then the hot water flowing between the two layers of the container [202] heats up the mixed materials indirectly.

3. The cooking tank [102] of claim 2, comprising a two-layer container [303] with an electro gearbox mounted on the top [302], and an agitator inside which blades of the agitator moves by a vertical shaft, which rotates by the electro gearbox [302] and is concentric with the two-layer container and the agitator blades are at the maximum distance with the rotating shaft and nearest to the internal two-layer container surface which the mix is to be heated, cooked and pasteurized by the heat of hot water flowing between the two layers of the container [303] and a tank inlet [301] from the primary processing tank [101] is positioned on the top, and the outlet [305] to an extruder press [103] is at the bottom of container.

4. The extruder press [103] of claim 3, comprising a vertical pushing jack [402] that moves inside a vertical cylinder [403] and then a pneumatic pomp [404] mounted on the top imposes the required force to the cooked starch mix by the pushing jack [402] moving in the cylinder [403] extruding noodles and then noodles are to be collected in a drying tray [501].

5. The drying tray [104] of claim 4, comprising a drying tray [501] installed below the cylinder [403] to collect the extruded noodles, which float in the drying tray [501] in cold water to maintain their texture and then an escalator conveyor [502] is attached to the drying tray [501] conveying up the noodles to the primary mixer [108], which net shaped conveyor belt facilitate noodles to dry while moving up to the primary mixer [108] as a part of mixing and flavoring section [30].

6. The syrup production section of claim 1, further comprising primary processing tank [105], comprising a two-layer container [202] with an electro gearbox [203] mounted on the top, and an agitator [204] inside and then blades of the agitator [204] attached to a rotating vertical shaft, which rotates by the electro gearbox [203] and is concentric with the two-layer container to make a homogenous mix of raw materials for faloodeh syrup, which the container wall can transmit the heat of the hot water flowing between the two layers up to 90° C. in order to cause syrup pasteurization.

7. The tank inlet of claim 2 is positioned on the top, and the outlet [205] is at the bottom of container connected by a pipeline to a water chiller [106] to cool down the syrup before entering to the batch freezer [107].

8. The water chiller [106] of claim 7 facilitates decreasing the pasteurized syrup temperature before entering to a batch freezer [107] for energy conservation and reduce batch freezer [107] depreciation and then the syrup flows from primary processing tank outlet [205] through water chiller to the batch freezer [107] inlet.

9. The batch freezer [107] of claim 8, decreases syrup temperature to the freezing point while maintaining desirable viscosity and thickness, which the outlet of water chiller [106] enters to the batch freezer [107] and moves to the primary mixer [108] after reaching to a specific thickness and temperature.

10. The mixing and flavoring section of claim 1, further comprising: primary mixer [108] and secondary mixer [109].

11. The primary mixer of claim 10, comprising a cone shaped container [902] and a mixer [903] inside, that further comprising a mounted electro gearbox on the top, which provides the needed power for the rotation of a helix inside the conical container [904] and then the primary mixer [108] is the joint of faloodeh noodle production section and syrup production section and then dried noodles and frozen syrup enters to the primary mixer [108] through the inlet [901] on the top and mixed together by the helix mixer rotation which, the outlet [906] is designed as an extruder that is adjustable according to the weight of the mix inside the conical container.

12. The secondary mixer of claim 10, comprising a two-layer container [1002] with a horizontal helix [1003] connected to an electro gearbox [1004] which, the inlet of container [1001] is positioned on the top where the mixed noodles with syrup that is prepared in the primary mixer [108] enters to the secondary mixer [109] and then [1003] mixes noodles, syrup and all other ingredients without causing any damage to noodles and produces a homogenous and smooth mixture and helix [1003] rotation causes the mixture moves toward the outlet [1005] for discharge and delivery to a packaging machine.

13. The faloodeh (faloudeh) production line as claimed in any preceding claims requires 20 sq. meter area for producing 500 Kg. of product.

14. All the faloodeh (faloudeh) production line and machinery parts as claimed in claims 1 to 13 are made up of stainless steel or any other material that is washable or disinfect able and do not intent for chemical reaction with food.
